(19) United States
(12) Patent Application Publication
(10) Pub. No.: US 2024/0022145 A1
(43) Pub. Date: Jan. 18, 2024

(54) METHOD FOR MANUFACTURING STATOR AND WELDING APPARATUS

(71) Applicant: TOYOTA JIDOSHA KABUSHIKI KAISHA, Toyota-shi (JP)

(72) Inventors: Yasunori SUZUKI, Kasugai-shi (JP); Tsuyoshi Matsuo, Nisshin-shi (JP); Hideki Manabe, Okazaki-shi (JP)

(73) Assignee: TOYOTA JIDOSHA KABUSHIKI KAISHA, Toyota-shi (JP)

(21) Appl. No.: 18/338,619

(22) Filed: Jun. 21, 2023

(30) Foreign Application Priority Data
Jul. 13, 2022 (JP) 2022-112543

(51) Int. Cl. H02K 15/00; H02K 15/02; B23K 9/16; B23K 37/04

(52) U.S. Cl. CPC H02K 15/0068; H02K 15/02; B23K 9/16; B23K 37/0452; B23K 37/0443; B23K 2101/36

(57) ABSTRACT

A method for manufacturing a stator in the related art has a problem that the size of a stator cannot be sufficiently reduced. A method for manufacturing a stator according to the present disclosure includes: a welding end holding process of holding, by welding clamps, a coil end that is one end of wiring composing each of the coils and another wiring different from that of the coil; an electrode end holding process of holding an energizing position provided in the other wiring by a conductive electrode clamp; and a welding process of energizing the electrode clamp, and joining the coil end and the other wiring clamped by the welding clamps to each other by the TIG welding.

### CROSS REFERENCE TO RELATED APPLICATIONS

This application is based upon and claims the benefit of priority from Japanese patent application No. 2022-112543, filed on Jul. 13, 2022, the disclosure of which is incorporated herein in its entirety by reference.

### BACKGROUND

The present disclosure relates to a method for manufacturing a stator and a welding apparatus, and, in particular, to a method for manufacturing a stator in which end parts of segment coils provided in the stator are joined by TIG welding and a welding apparatus that performs the TIG welding.

In recent years, the demand for an electric vehicle (a hybrid electric vehicle, a plug-in hybrid electric vehicle, a battery electric vehicle, etc.) that use a motor as a driving power source has been increasing. A stator and a rotor are used for a motor mounted on such a battery electric vehicle. Further, a plurality of segment coils are used for the stator. Note that the segment coils are divided so as to compose three current paths when the number of driving phases of the motor is three. Further, the divided segment coils are composed of a plurality of segment coils for each current path. At this time, a plurality of segment coils composing one current path are electrically connected to each other by welding their coil ends to each other by Tungsten Inert Gas (TIG) welding. A TIG welding technique for segment coils is disclosed in Japanese Unexamined Patent Application Publication No. 2005-130577.

A method for manufacturing a stator disclosed in Japanese Unexamined Patent Application Publication No. 2005-130577 is a method for manufacturing a stator for respectively positioning pairs of segment ends of a segment-inserted stator core including a stator core having an annular shape and a main surface perpendicular to an axial direction thereof, in which a plurality of slots that penetrate in the axial direction and extend in a radial direction are formed side by side in a circumferential direction, and a plurality of segment members inserted into the slots, in which each segment end protrudes from the main surface and pairs of the segment ends adjacent to each other and welded to each other respectively form a segment end pair, a plurality of the segment end pairs are arranged in rows in the radial direction to form groups of segment end pairs, and a plurality of the groups of the segment end pairs are arranged in the circumferential direction, the method including a positioning process in which a first plate including a plurality of first end pair group insertion windows extending in a radial direction corresponding to the respective groups of the segment end pair and formed side by side in the circumferential direction and a plurality of first protrusions arranged side by side at predetermined intervals in the radial direction in which a first inner circumferential wall composing the first end pair group insertion windows protrudes toward a first circumferential direction of one of the circumferential directions is disposed on the main surface side of the stator core, the groups of the segment end pairs are inserted into the first end pair group insertion windows so that a tip side of each of the segment ends protrudes from the first plate, a second plate including a plurality of second end pair group insertion windows extending in the radial direction corresponding to the respective groups of the segment end pairs and formed side by side in the circumferential direction and a plurality of second protrusions arranged side by side at predetermined intervals in the radial direction in which a second inner circumferential wall composing the second end pair group insertion windows protrudes toward a second circumferential direction opposite to the first circumferential direction of the circumferential directions is disposed on a side of the first plate opposite to the stator core, the groups of the segment end pairs are inserted into the second end pair group insertion windows so that at least each welding end part of the segment ends to be welded protrudes from the second plate, the first plate is rotated in the first circumferential direction and the second plate is rotated in the second circumferential direction, the first protrusions are moved in the first circumferential direction and respectively inserted between the segment end pairs composing the group of the segment end pairs, and the second protrusions are moved in the second circumferential direction and respectively inserted between the segment end pairs composing the group of the segment end pairs, to thereby position each of the segment end pairs.

### SUMMARY

However, in the method for manufacturing a stator disclosed in Japanese Unexamined Patent Application Publication No. 2005-130577, there is a problem that the length of the coil end part has to be increased in order to bring an electrode for TIG welding into contact with the coil end part to be welded and thus it is difficult to reduce the size of the stator.

The present disclosure has been made in order to solve the above-described problem, and an object thereof is to reduce the size of a stator including coils.

A first exemplary aspect is a method for manufacturing a stator for performing Tungsten Inert Gas (TIG) welding with regard to end parts of a plurality of coils arranged side by side in an annular stator core in a circumferential direction thereof, the method including:
a welding end holding process of holding, by welding clamps, a coil end that is one end of wiring composing each of the coils and another wiring different from that of the coil;
an electrode end holding process of holding an energizing position provided in the other wiring by a conductive electrode clamp; and
a welding process of energizing the electrode clamp, and joining the coil end and the other wiring clamped by the welding clamps to each other by the TIG welding.

Another exemplary aspect is a welding apparatus configured to perform Tungsten Inert Gas (TIG) welding with regard to end parts of a plurality of coils arranged side by side in an annular stator core in a circumferential direction thereof, the welding apparatus including: a welding clamp control unit configured to hold, by welding clamps, a coil end that is one end of wiring composing each of the coils and another wiring different from that of the coil; an electrode clamp control unit configured to hold an energizing position provided in the other wiring by a conductive electrode clamp; and a torch control unit configured to control a torch that joins the coil end and the other wiring to each other by the TIG welding.

In the method for manufacturing a stator and the welding apparatus according to the present disclosure, the length of a coil end to be welded is reduced by performing TIG welding while an electrode clamp is in contact with another position different from the coil end to be welded.

According to the present disclosure, it is possible to reduce the size of a stator including coils.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram for explaining a clamp position in a method for manufacturing a stator according to a first embodiment;

FIG. 2 is a diagram showing the clamp position in the method for manufacturing a stator according to the first embodiment as viewed from a top surface of a stator;

FIG. 3 is a diagram for explaining a first example of a welding clamp in the method for manufacturing a stator according to the first embodiment;

FIG. 4 is a diagram for explaining a second example of the welding clamp in the method for manufacturing a stator according to the first embodiment;

FIG. 5 is a flowchart for explaining a flow of the method for manufacturing a stator according to the first embodiment; and

FIG. 6 is a block diagram for explaining a brief overview of a welding apparatus according to the first embodiment.

### DESCRIPTION OF EMBODIMENTS

For the clarification of the description, the following descriptions and the drawings are partially omitted and simplified as appropriate. Further, the same elements are denoted by the same reference symbols throughout the drawings, and redundant descriptions are omitted as necessary.

### First Embodiment

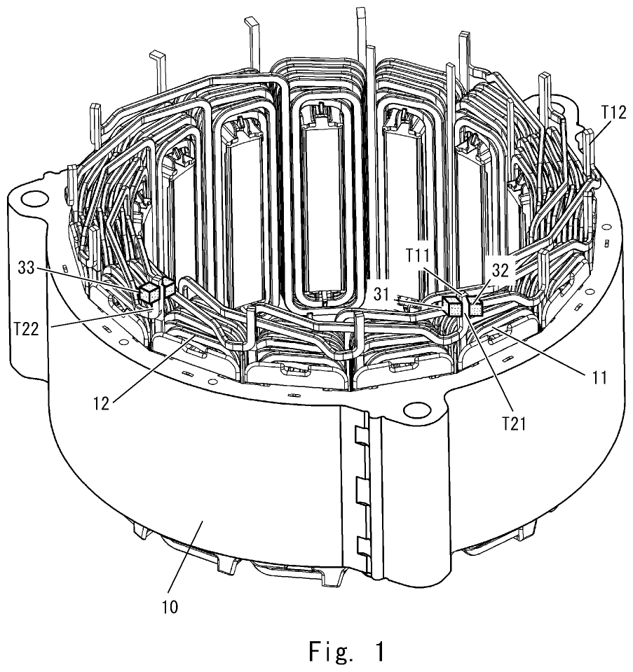

In a method for manufacturing a stator according to a first embodiment, Tungsten Inert Gas (TIG) welding is performed with regard to a plurality of coils arranged side by side in an annular stator core in a circumferential direction thereof. Further, in the method for manufacturing a stator according to the first embodiment, one of the features is a method for clamping end parts (hereinafter referred to as coil ends) of coils during welding. FIG. 1 is a diagram for explaining a clamp position in the method for manufacturing a stator according to the first embodiment.

Note that coils provided in a stator include segment coils formed in a U-shape and cassette coils formed in a spring shape. The segment coils are used for a distributed winding stator and the cassette coils are used for a concentrated winding stator. A description will be given below of a method for manufacturing a stator including cassette coils and a welding apparatus that performs TIG welding with regard to the stator. However, the welding apparatus also can perform TIG welding with regard to segment coils as well.

Further, a description will be given below of an example of a case in which a first coil end, which is an end part of a first cassette coil, is welded to a second coil end, which is an end part of a second cassette coil. That is, in the following description, another wiring is the second coil end which is the end part of the second cassette coil. However, wiring of the first coil end to be welded is not limited to that of the second coil end only, and various types of wiring, such as bus bars and power lines, can be objects to be welded.

First, the method for manufacturing a stator according to the first embodiment includes at least a welding end holding process, an electrode end holding process, and a welding process. Then, in the welding end holding process, a coil end, which is one end of wiring composing each coil, and another wiring, which is different from that of the coil, are held by welding clamps. In the electrode end holding process, an energizing position provided in the other wiring is held by a conductive electrode clamp. In the welding process, the electrode clamp is energized, and the coil end clamped by the welding clamp is joined to the other wiring by TIG welding.

Note that, when two cassette coils are used as an example, a coil end is the first coil end and another wiring is the second coil end, and the energized position is a third coil end. Namely, the method for manufacturing a stator according to the first embodiment using these coil ends is as follows. In the welded end holding process, the first coil end, which is one end of the wiring composing the first cassette coil, and the second coil end, which is the other end of the wiring composing the second cassette coil adjacent to the first cassette coil across one or more cassette coils, are held by the welding clamps. In the electrode end holding process, the third coil end, which is the end part opposite to the second coil end of the second cassette coil, is held by the conductive electrode clamp. In the welding process, the electrode clamp is energized, and the first coil end and the second coil end clamped by the welding clamp are joined to each other by the TIG welding.

A description will be given below of an example of a case in which a cassette coil 11 is used as the first cassette coil and a cassette coil 12 is used as the second cassette coil. However, the first cassette coil and the second cassette coil are merely for indicating a relation between two cassette coils including wiring to be welded, and therefore the coil cassette 12 may instead be used as the first cassette coil and the coil cassette 11 may instead be used as the second cassette coil.

Further, although the method for manufacturing a stator according to the first embodiment can be applied regardless of the number of driving phases of a motor, a method for manufacturing a stator applied to a three-phase drive motor will be described below.

An example in FIG. 1 shows two cassette coils in which coil wires are welded to a stator core 10 among a plurality of cassette coils corresponding to one predetermined phase. More specifically, FIG. 1 shows the first cassette coil (e.g., the cassette coil 11) and the second cassette coil (e.g., the cassette coil 12) among the cassette coils mounted on the stator core 10. Further, since the example shown in FIG. 1 is a three-phase drive motor, cassette coils of the same phase are arranged at intervals of three cassette coils in the circumferential direction of the stator core 10.

As shown in FIG. 1, the cassette coil 11 has a first coil end (e.g., a coil end T11) protruding from the cassette coil 11 and a coil end T12 extending toward the cassette coil of the same phase adjacent to the cassette coil 11 on the opposite side of the cassette coil 12. The cassette coil 12 also has a coil end T21 extending toward the cassette coil 11 to the position of the coil end T11 of the cassette coil 11 and a third coil end (e.g., a coil end T22) which is an end part thereof opposite to the coil end T21 and which protrudes from the cassette coil 11.

In the method for manufacturing a stator according to the first embodiment, two coil ends of one cassette coil at a position to be welded near the coil ends of another cassette coil are clamped by welding clamps 31 and 32. Further, in TIG welding, it is necessary to bring an electrode that serves as a current path into contact with a base material to be welded. In the method for manufacturing a stator according to the first embodiment, the coil end of one of the two cassette coils to be welded is held at a position different from the position to be welded by a conductive electrode clamp. In the example shown in FIG. 1, the coil end T21 (e.g., the third coil end) of the cassette coil 12 is held by an electrode clamp 33. Note that a coil end held by the electrode clamp 33 may be the coil end T12 of the cassette coil 12.

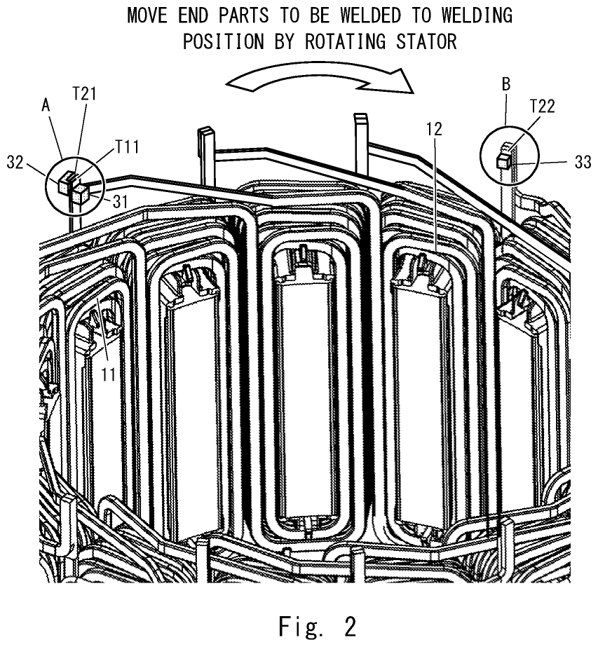

Next, a welding position, which is a position at which the coil end T11 and the coil end T21 to be welded are clamped, and an electrode position at which the coil end T22 is clamped by the electrode clamp, which positions are set in the method for manufacturing a stator according to the first embodiment, will be described. FIG. 2 shows a clamp position in the method for manufacturing a stator according to the first embodiment as viewed from a top surface of the stator.

In the method for manufacturing a stator according to the first embodiment, a welding apparatus 1, which will be described later, is used. As shown in FIG. 2, by rotating the stator, the welding apparatus 1 sequentially moves the coil ends T11 and T21 arranged in the circumferential direction of the stator core 10 to a welding position A, which is a movable range of the welding clamps 31 and 32. Further, by rotating the stator, the welding apparatus 1 sequentially moves the coil ends T12 arranged in the circumferential direction of the stator core 10 to an electrode position B, which is a movable range of the electrode clamp 33.

Note that, in the method for manufacturing a stator according to the first embodiment, the stator core 10 may be fixed and then the welding clamps 31 and 32 and the electrode clamp 33 may be moved in accordance with the positions of the coil ends arranged in the circumferential direction of the stator core 10.

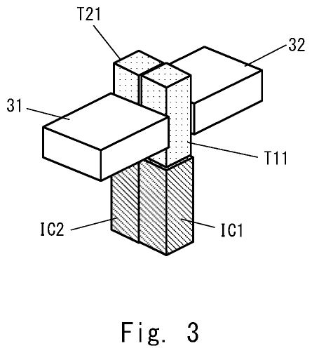

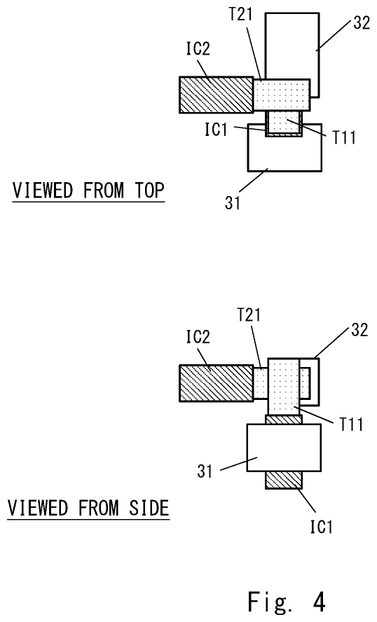

Next, an example of the welding clamp that holds the coil end T11 and the coil end T21 to be welded will be described. FIG. 3 is a diagram for explaining a first example of the welding clamp in the method for manufacturing a stator according to the first embodiment, and FIG. 4 is a diagram for explaining a second example of the welding clamp in the method for manufacturing a stator according to the first embodiment. Note that, in order to show the shape of a clamp jig, a perspective view of the clamp jig is shown in FIG. 3, and a diagram of the clamp jig as viewed from the top thereof and a diagram of the clamp jig as viewed from the side thereof are shown in FIG. 4.

The first example shown in FIG. 3 is for explaining the welding clamps 31 and 32 when the end parts of the coil end T11 and the coil end T21 face in the same direction. Further, the second example shown in FIG. 4 is for explaining the welding clamps 31 and 32 when a direction in which the end part of the coil end T11 faces intersects a direction in which the end part of the coil end T21 faces. As shown in FIGS. 3 and 4, the coil ends T11 and T21 to be welded are clamped in a state in which insulating coatings IC1 and IC2 have been respectively peeled off so as to prevent the wirings from being conductive with respect to each other. The welding clamps 31 and 32 hold the coil ends T11 and T21 so as to be in contact with the parts from which the insulating coatings IC1 and IC2 have been peeled off. Further, as shown in FIGS. 3 and 4, in the method for manufacturing a stator according to the first embodiment, the electrode clamp is at the electrode position B, which is different from the welding position A. Therefore, in the welding apparatus 1 according to the first embodiment, the lengths of the metal parts, from which the insulating coatings IC1 and IC2 are peeled off to serve as current paths, can be reduced to minimum required lengths as welding parts. That is, in the method for manufacturing a stator according to the first embodiment, when the length that metal is exposed is determined, the length that the electrode clamp is made to contact is not required. Therefore, in the method for manufacturing a stator according to the first embodiment, it is possible to reduce the size of the stator by reducing a metal exposure range of a part to be welded.

Further, in the first example shown in FIG. 3, the coil end T11 and the coil end T21 are clamped from both sides thereof in the direction perpendicular to the direction in which the coil end T11 and the coil end T21 face each other by using the welding clamps 31 and 32. For example, the welding clamps 31 and 32 can have a structure in which a tapered surface is included on the side thereof and as the welding clamp 31 approaches the welding clamp 32, the coil end T11 approaches the coil end T21. That is, the clamp jig shown in FIG. 3 includes a first clamp jig 31 that fixes a position of the first coil end T11 and a position of the second coil end T21, and a second clamp jig 32 that fixes a position of the first coil end T11 and a position of the second coil end T21 from a direction opposite to a direction in which the first clamp jig 31 fixes the positions.

Further, in the second example shown in FIG. 4, the clamp jig includes a first clamp jig (e.g., the welding clamp 31) that presses the first coil end T11 to the side of the second coil end T21, and a second clamp jig (e.g., the welding clamp 32) that presses the second coil end T21 to the side of the first coil end T11. As shown in FIG. 4, in the method for manufacturing a stator according to the first embodiment, the clamp jigs that serve as the welding clamps 31 and 32 can press the insulating coating part of the coil end part since it is not required to energize it.

Features of a clamp used for performing TIG welding will be described below. First, high material strength or a shape capable of maintaining strength is required for the welding clamps 31 and 32 since they generate pushing pressure that brings two coil end parts to be welded into contact when clamping. Further, although the electrode clamp 33 is required to have high electrical conductivity, it is not required to have strength enough to bear a clamp load, since it is only necessary for the clamps to be able to come into contact with an uncoated metal wiring.

For example, when an attempt is made to implement the functions of the electrode clamp and the welding clamp, by one clamp jig, unlike in the method for manufacturing a stator according to the first embodiment, the selection of materials and the shape of the clamp jig are highly constrained. However, in the method for manufacturing a stator according to the first embodiment, the welding clamp requires only the function of repeatedly holding the coil ends T11 and T21 to be welded, and the electrode clamp requires only conductivity. Therefore, the method for manufacturing a stator according to the first embodiment has the flexibility in designing shapes and characteristics of the welding clamp and the electrode clamp as appropriate in accordance with the performance required for each of the clamps. Thus, in the method for manufacturing a stator according to the first embodiment, the size of the clamp jig can be reduced and the durability of the clamp jig can be improved.

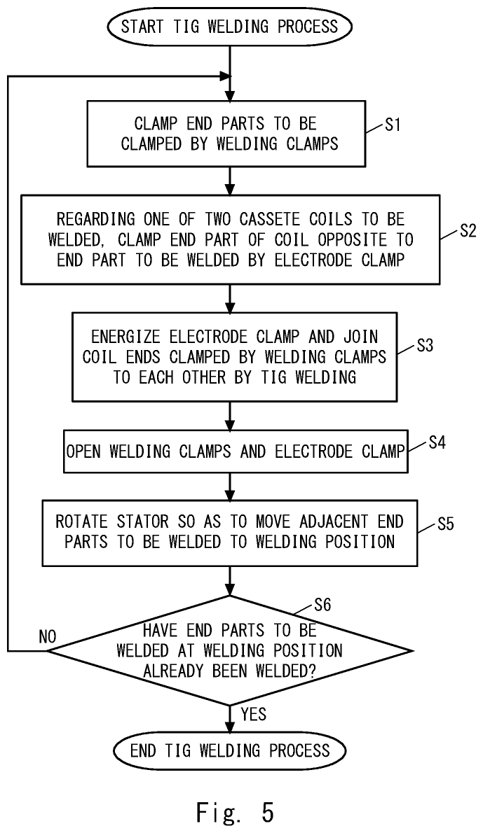

A flow of the method for manufacturing a stator according to the first embodiment will be described below. FIG. 5 is a flowchart for explaining the flow of the method for manufacturing a stator according to the first embodiment.

As shown in FIG. 5, in the method for manufacturing a stator according to the first embodiment, the end parts to be welded (e.g., the coil ends T11 and T21) are first clamped by the welding clamps 31 and 32 (Step S1). Next, regarding one of two cassette coils to be welded (e.g., the cassette coil 12), an end part of the coil (e.g., the coil end T22) opposite to the end part to be welded (the coil end T21) is clamped by the electrode clamp 33 (Step S2).

Next, in the welding apparatus 1 according to the first embodiment, the electrode clamp 33 is energized and the coil ends T11 and T21 clamped by the welding clamps 31 and 32 are joined to each other by TIG welding (Step S3). Then, when the TIG welding is completed, the welding clamps 31 and 32 and the electrode clamp 33 are opened, whereby the clamp jig is separated from the coil ends and the coil ends are released (Step S4).

Next, in the first embodiment, the stator is rotated after Step S4 so as to move the adjacent end parts to be welded to the welding position A (Step S5). Note that, in Step S5, the coil end to be clamped by the electrode clamp 33 is the third coil end of the adjacent cassette coil. Then, after the stator is rotated, the coil ends located at the welding position A are observed by, for example, a camera, and when the end parts to be welded have already been welded, a welding process is completed, while when they have not been welded yet, the coil ends newly arrived (e.g., located) at the welding position A are welded in accordance with Steps S1 to S5 (Step S6).

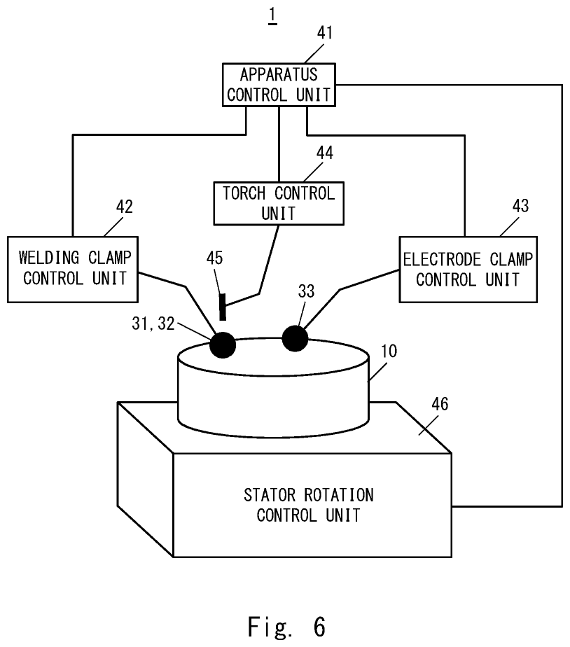

The welding apparatus used in the method for manufacturing a stator according to the first embodiment will be described below. FIG. 6 is a block diagram for explaining a brief overview of the welding apparatus 1 according to the first embodiment. The block diagram shown in FIG. 6 is a functional block diagram of the welding apparatus 1, and the actual shape of the apparatus varies depending on the conditions of factory equipment etc.

As shown in FIG. 6, the welding apparatus 1 includes an apparatus control unit 41, a welding clamp control unit 42, an electrode clamp control unit 43, a torch control unit 44, a stator rotation control unit 46, the welding clamps 31 and 32, the electrode clamp 33, and a torch 45. Note that, although not shown in FIG. 6, the welding apparatus 1 uses various types of sensors, such as a camera, in order to check the state of welding performed in the stator, and the respective positions of the welding clamps 31 and 32 and the torch 45.

The apparatus control unit 41 provides operation instructions to the welding clamp control unit 42, the electrode clamp control unit 43, the torch control unit 44, and the stator rotation control unit 46 in accordance with the flowchart shown in FIG. 5. Further, the apparatus control unit 41 uses a sensor such as a camera to determine whether or not the end parts to be welded at the welding position A have been welded. That is, the apparatus control unit 41 performs the process of Step S6 in FIG. 5.

The welding clamp control unit 42 holds the coil end, which is one end of the wiring composing each of the coils, and another wiring different from that of the coil by the welding clamps. More specifically, the welding clamp control unit 42 controls the welding clamps 31 and 32 so that the first coil end (e.g., the coil end T11), which is one end of the wiring composing the first cassette coil (e.g., the cassette coil 11), and the second coil end (e.g., the coil end T21), which is the other end of the wiring composing the second cassette coil (e.g., the cassette coil 12) adjacent to the cassette coil 11 across one or more cassette coils, are held by the welding clamps 31 and 32. That is, the welding clamp control unit 42 performs the processes of Steps S1 and S4 in FIG. 5.

The electrode clamp control unit 43 holds an energizing position provided on the other wiring by a conductive electrode clamp. More specifically, the electrode clamp control unit 43 controls the electrode clamp 33 so that the third coil end (e.g., the coil end T22), which is the end part opposite to the coil end T21 of the cassette coil 12, is held by the conductive electrode clamp 33. That is, the electrode clamp control unit 43 performs the processes of Steps S2 and S4 in FIG. 5.

The torch control unit 44 controls a torch that joins the coil end to other wiring by TIG welding. More specifically, the torch control unit 44 controls a position and a discharge state of the torch that generates an arc between the base materials (the exposed metals of the coil ends T11 and T21) to be welded. The torch control unit 44 also controls an ejection state of an inert gas (e.g., an argon gas) ejected from the torch 45 to an area near the welding point. That is, the torch control unit 44 performs the process of Step S3 in FIG. 5. Note that the process of energizing the electrode clamp 33 in Step S3 is performed by the electrode clamp control unit 43.

The stator rotation control unit 46 moves a next coil end adjacent to the coil end to be welded in the direction opposite to the direction in which the stator is rotated to a position of the coil end before the stator is rotated. More specifically, the stator rotation control unit 46 rotates the stator core 10 after the welding process (Step S4 in FIG. 5) so as to move the third cassette coil and a fourth cassette coil adjacent to the cassette coils 11 and 12 in the direction opposite to the direction in which the stator is rotated to a position of the cassette coils 11 and 12 before the stator is rotated. That is, the stator rotation control unit 46 performs the process of Step S5 in FIG. 5.

Note that, in the welding apparatus 1, although the stator core 10 is rotated, another method in which the stator core 10 is fixed and the welding clamps 31 and 32, the electrode clamp 33, and the torch 45 are moved may be employed. However, when the stator core 10 is rotated, the movable range of each of the welding clamps 31 and 32, the electrode clamp 33, and the torch 45 can be set narrower, and hence the size of the apparatus related to the welding clamps 31 and 32, the electrode clamp 33, and the torch 45 can be reduced.

As described above, in the method for manufacturing a stator according to the first embodiment, the electrode clamp 33 is brought into contact with the cassette coil at a position distant from the welding clamps 31 and 32 which require high pushing pressure. By doing so, in the method for manufacturing a stator according to the first embodiment, the area of the coil end to be welded from which the coating has been peeled off is reduced, and hence the length of the coil end is reduced. Further, by reducing the length of the coil end, the size of the stator which has been completed using the method for manufacturing a stator according to the first embodiment is reduced.

Further, by setting the positions where the welding clamps 31 and 32 clamp and the position where the electrode clamp 33 clamp so that they are distant from each other, in the method for manufacturing a stator according to the first embodiment, the welding clamp and the electrode clamp can be freely designed in accordance with the characteristics required for the welding point and the electrode contact point. Thus, by using the method for manufacturing a stator according to the first embodiment, the durability of each clamp can be improved and the size of each clamp can be reduced.

Further, the welding apparatus 1 according to the first embodiment rotates the stator core 10, thereby switching the welding points. By doing so, in the welding apparatus 1 according to the first embodiment, the size of the apparatus can be reduced and a high durability of the apparatus can be achieved by reducing movable parts.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a stator for performing Tungsten Inert Gas (TIG) welding with regard to end parts of a plurality of coils arranged side by side in an annular stator core in a circumferential direction thereof, the method comprising:
a welding end holding process of holding, by welding clamps, a coil end that is one end of wiring composing each of the coils and another wiring different from that of the coil;
an electrode end holding process of holding an energizing position provided in the other wiring by a conductive electrode clamp; and
a welding process of energizing the electrode clamp, and joining the coil end and the other wiring clamped by the welding clamps to each other by the TIG welding.

2. The method according to claim 1, comprising a next welding preparation process of rotating the stator core after the welding process and moving a next coil end adjacent to a coil end to be welded in a direction opposite to a direction in which the stator core is rotated to a position of the coil end before the stator core is rotated.

3. The method according to claim 1, wherein the welding clamp performs the welding end holding process by means of a first clamp jig configured to press the coil end to a side of the other wiring and a second clamp jig configured to press the other wiring to a side of the coil end.

4. The method according to claim 1, wherein the welding clamp performs the welding end holding process by means of a first clamp jig configured to fix a position of the coil end and a position of the other wiring, and a second clamp jig configured to fix a position of the coil end and a position of the other wiring from a direction opposite to a direction in which the first clamp jig fixes the positions.

5. A welding apparatus configured to perform Tungsten Inert Gas (TIG) welding with regard to end parts of a plurality of coils arranged side by side in an annular stator core in a circumferential direction thereof, the welding apparatus comprising:
a welding clamp control unit configured to hold, by welding clamps, a coil end that is one end of wiring composing each of the coils and another wiring different from that of the coil;
an electrode clamp control unit configured to hold an energizing position provided in the other wiring by a conductive electrode clamp; and
a torch control unit configured to control a torch that joins the coil end and the other wiring to each other by the TIG welding.

6. The welding apparatus according to claim 5, further comprising a stator rotation control unit configured to rotate the stator core and move a next coil end adjacent to a coil end to be welded in a direction opposite to a direction in which the stator core is rotated to a position of the coil end before the stator core is rotated.
